(19) United States
(12) Patent Application Publication
(10) Pub. No.: US 2026/0287168 A1
(43) Pub. Date: Sep. 24, 2026

(54) LIGHTING MECHANISM AND CEILING FAN LAMP

(71) Applicant: STAR MOUNT ENTERPRISE LIMITED, HONG KONG (CN)

(72) Inventors: Xianghua HUANG, HONG KONG (CN); Guanpian LI, HONG KONG (CN); Shoucheng WU, HONG KONG (CN)

(21) Appl. No.: 19/203,258

(22) Filed: May 9, 2025

(30) Foreign Application Priority Data
Mar. 20, 2025 (CN) 202520499095.X

(51) Int. Cl. F21V 33/00; F21V 21/08; F21V 23/06; F21V 27/02; F21Y 115/10

(52) U.S. Cl. CPC F21V 33/0096; F21V 21/08; F21V 23/06; F21V 27/02; F21Y 2115/10

(57) ABSTRACT

A lighting mechanism and a ceiling fan lamp are provided. The lighting mechanism includes a lamp holder component and a controller. The lamp holder component is configured to provide lighting. The controller is integrated and arranged on the lamp holder component or inside the lamp holder component, and is connected with a power supply end to control a lighting function of the lamp holder component. The controller is integrated and arranged on the lamp holder component or inside the lamp holder component, and the demands of additional components and connecting wires are reduced, so that the installation process is simple and convenient, the installation time is saved, the installation cost and difficulty are reduced, and the risk of long-time high-place operation is reduced.

### CROSS-REFERENCE TO RELATED APPLICATIONS

This application claims priority to Chinese application No. 202520499095.X filed on 20 Mar. 2025, titled “LIGHTING MECHANISM AND CEILING FAN LAMP”, the entire content of which is hereby incorporated by reference into this application.

### TECHNICAL FIELD

The present disclosure belongs to the technical field of lighting equipment, and particularly relates to a lighting mechanism and a ceiling fan lamp.

### BACKGROUND

In that prior art, the control pow supply of the ceiling fan lamp is always installed in the top cover, and the top cover needs a large space to accommodate the control power supply and more wire joints. Moreover, when the ceiling fan lamp is installed by the consumer, a plurality of electric wires need to be connected from the control power supply of the ceiling fan lamp to the motor and the lamp holder respectively. All these wires pass through the inside of the hanging rod, and are difficult to thread. The workload is heavy, and sometimes wiring errors or electric wire damages may occur.

On the other hand, based on the characteristics of the ceiling fan lamp, the lamp holder component needs to be installed on the motor housing on site by the consumer.

According to the prior art, a plurality of screws are usually used for connection, and there are problems of alignment difficulties and cumbersome installation of a plurality of screws during installation. Moreover, the mechanical structure and screw hole positions of different lamp holders are different, and the connection between the lamp holder and the motor is also unique, so universality cannot be realized.

### SUMMARY

For this reason, the main purpose of the present disclosure is to provide a lighting mechanism and a ceiling fan lamp.

In order to reach the purpose, the technical scheme of the present disclosure is realized as follows.

A lighting mechanism provided by the embodiment of the present disclosure includes a lamp holder component and a controller.

The lamp holder component is configured to provide lighting.

The controller is integrated and arranged on the lamp holder component or inside the lamp holder component, and is connected with a power supply end to control a lighting function of the lamp holder component.

In the scheme, the controller is connected with a power supply end through a cable with a plug connector.

In the scheme, the lamp holder component includes a lamp disc and a lamp cover. The front of the lamp disc is covered with the lamp cover, and the back of the lamp disc is provided with the controller.

In the scheme, the lamp disc and the controller are of an integrated structure.

In the scheme, the controller is provided with a cable duct for cable penetration.

In the scheme, the controller includes a first power source, a second power source, a human-computer interaction control unit and an LED (Light Emitting Diode) driving unit.

The first power source has an input end connected with a power supply end and an output end respectively connected with the second power source and the LED driving unit, and is configured to convert the mains power of the power supply end into direct current and supply direct current for the second power source and the LED driving unit.

The second power source has an input end connected with the first power source and an output end connected with the human-computer interaction control unit, and is configured to reduce the voltage of the direct current and supply the direct current for the human-computer interaction control unit.

The man-machine interaction control unit is connected with the LED driving unit, and is configured to output an LED control signal to the LED driving unit according to a received control signal.

The LED driving unit is connected with the lamp holder component, and is configured to control a lighting state of the lamp disc of the lamp holder component according to the LED control signal.

The embodiment of the present disclosure further provides a ceiling fan lamp. The ceiling fan lamp includes a ceiling fan body and the lighting mechanism according to any one in the scheme.
wherein the lighting mechanism is connected with the ceiling fan body; and
wherein the controller of the lighting mechanism is electrically connected with the ceiling fan body, and is configured to control a lighting function of the lamp holder component and a working state of the ceiling fan body.

In the scheme, the lighting mechanism is connected with the ceiling fan body through a quick-connect mechanism.

In the scheme, the quick-connect mechanism includes an installation disc and pegs.

The installation disc is arranged on the ceiling fan body and provided with at least two installation holes matched with the pegs at intervals along the circumferential direction.

The pegs are arranged at corresponding positions on the back of the lamp disc.

In the scheme, the installation disc is provided with M-shaped compression spring plates at corresponding positions of the installation holes. The M-shaped compression spring plate is configured to position the pegs installed in the installation holes.

In the scheme, the installation hole includes a jacking hole and a rotary track sequentially connected along the circumferential direction. The diameter of the top entry hole is larger than the width of the rotary track.

In the scheme, the ceiling fan body is connected with a hanging rack arranged on a roof through a hanging rod. The power supply end passing through the hanging rod and the ceiling fan body through a power cord to be electrically connected with the controller.

In the scheme, the controller further includes a motor control unit.

The output end of the first power source is further connected with the motor control unit, and is further configured to convert mains power of the power supply end into direct current and supply direct current for the motor control unit.

The human-computer interaction control unit is further connected with the motor control unit, and is further configured to output a motor control signal to the motor control unit according to the received control signal.

The motor control unit is connected with the ceiling fan body, and is configured to control a working state of a motor of the ceiling fan body according to the motor control signal.

Compared with the prior art, the controller is integrated and arranged on the lamp holder component or inside the lamp holder component, and the demands of additional components and connecting wires are reduced, so that the installation process is simple and convenient, the installation time is saved, the installation cost and difficulty are reduced, and the risk of long-time high-place operation is reduced.

### BRIEF DESCRIPTION OF THE DRAWINGS

Attached figures, which form a part of the specification and are provided for further understanding of the present disclosure, show the preferred embodiments of the present disclosure, and explain the principle of the present disclosure together with the description, but not by way of limitation with regard to the present disclosure. In the attached figures,

FIG. 1 is a structure diagram of a lighting mechanism provided by a first embodiment of the present disclosure.

FIG. 2 is a structure diagram of a lighting mechanism provided by a second embodiment of the present disclosure.

FIG. 3 is a section view of a lighting mechanism provided by a second embodiment of the present disclosure.

FIG. 4 is a functional block diagram of a controller in a lighting mechanism provided by an embodiment of the present disclosure.

FIG. 5 is a structure diagram of a ceiling fan lamp provided by a third embodiment of the present disclosure.

FIG. 6 is a section view of a ceiling fan lamp provided by a third embodiment of the present disclosure.

FIG. 7 is an upward view of a ceiling fan body provided by a third embodiment of the present disclosure.

FIG. 8 is a structure diagram of a peg in a ceiling fan lamp provided by a third embodiment of the present disclosure.

FIG. 9 is a local structure diagram of a peg and an installation hole in an unmatched state in a ceiling fan lamp provided by a third embodiment of the present disclosure.

FIG. 10 is a local structure diagram of a peg and an installation hole in a matched state in a ceiling fan lamp provided by a third embodiment of the present disclosure.

FIG. 11 is a local structure diagram of a peg and an installation hole in a disassembled state in a ceiling fan lamp provided by a third embodiment of the present disclosure.

### DETAILED DESCRIPTION OF THE EMBODIMENTS

In order to make the objectives, technical solutions and advantages of the present disclosure clearer, the present disclosure will be further described hereinbelow with reference to the attached figures and embodiments thereof. It shall be understood that, the embodiments described herein are only intended to illustrate but not to limit the present disclosure.

Same or similar mark numbers in the attached figures of the embodiment of the present disclosure correspond to same or similar parts; in the description of the present disclosure, it needs to be illustrated that the indicative direction or position relations of the terms such as “upper”, “lower”, “left”, “right”, “inside” and “outside” are direction or position relations illustrated based on the attached figures, just for facilitating the description of the present disclosure and simplifying the description, but not for indicating or hinting that the indicated device or element must be in a specific direction and is constructed and operated in the specific direction, and therefore, the terms for describing the position relations in the attached figures are used for illustrative description only, but cannot be understood as the restriction of the present disclosure. For ordinary skilled in the part, the specific meanings of the terms can be understood according to specific conditions.

It should be noted that in this specification, the term “comprise”, “include”, or any other variant thereof is intended to cover a non-exclusive inclusion, so that a process, an article, or an apparatus that includes a list of elements not only includes those elements but also includes other elements that are not expressly listed, or further includes elements inherent to such process, article, or apparatus. In absence of more constraints, an element preceded by “includes a . . . ” does not preclude existence of other identical elements in the process, article, or apparatus that includes the element.

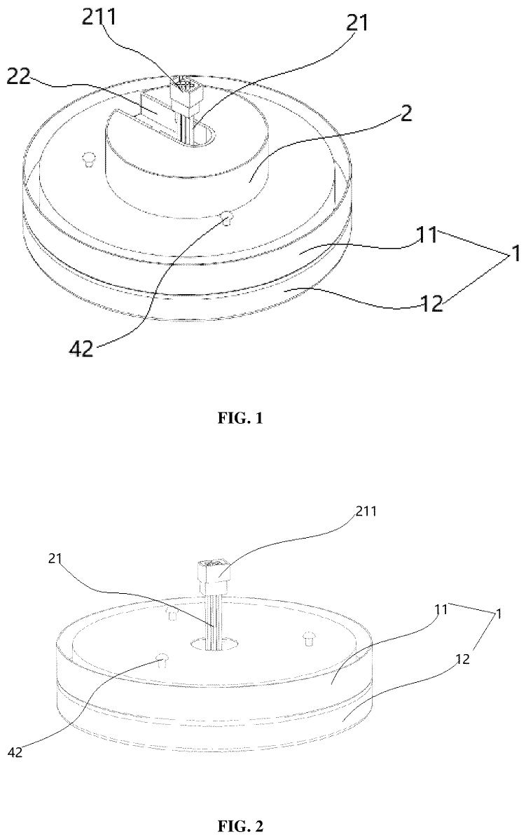

A lighting mechanism provided by a first embodiment of the present disclosure, as shown in FIG. 1 and FIG. 4, includes a lamp holder component 1 and a controller 2.

The lamp holder component 1 is configured to provide lighting.

The controller 2 is integrated and arranged on the lamp holder component 1, and is connected with a power supply end to control a lighting function of the lamp holder component 1.

The controller 2 is integrated and arranged on the lamp holder component 1, and the demands of additional components and connecting wires are reduced, so that the installation process is simple and convenient, the installation time is saved, the installation cost and difficulty are reduced, and the risk of long-time high-place operation is reduced.

The controller 2 is connected with the power supply end through a cable 21 with a plug connector 211. The installation and disassembly of the lighting mechanism are facilitated through the plug connector 211. At the same time, the reliability and safety of electrical connection are also ensured.

The lamp holder component 1 includes a lamp disc 11 and a lamp cover 12. The front of the lamp disc 11 is covered with the lamp cover 12, and the back of the lamp disc 11 is provided with the controller 2.

Additional installation space is saved by integrating the controller 2 on the lamp disc 11, so that the whole lighting mechanism is more compact and suitable for more space-constrained occasions.

The lamp disc 11 and the controller 2 are of an integrated structure, which reduces the number of components and connection steps during installation, so that the installation process is more convenient and faster.

The integrated structure enhances the connection strength between the lamp disc 11 and the controller 2, so that the stability of the overall structure is improved, and the risk of failure caused by loose components or poor connection is reduced.

The number of components and connection points are reduced, and the integrated structure enables the maintenance of the lighting mechanism to be simpler, so that the complexity and time cost during maintenance are reduced.

The controller 2 is provided with a wire duct 22 for the cable 21 to pass through, and the cable 21 is further fixed by the wire slot 22 and prevented from swinging at will.

Further, the controller 2 includes a first power source 23, a second power source 24, a human-computer interaction control unit 25 and an LED (Light Emitting Diode) driving unit 26.

The first power source 23 has an input end connected with a power supply end and an output end respectively connected with the second power source 24 and the LED driving unit 26, and is configured to convert mains power of the power supply end into direct current and supply direct current for the second power source 24 and the LED driving unit 26.

The second power source 24 has an input end connected with the first power source 23 and an output end connected with the human-computer interaction control unit 25, and is configured to reduce the voltage of the direct current and supply the direct current for the human-computer interaction control unit 25.

The man-machine interaction control unit 25 is connected with the LED driving unit 26, and is configured to output an LED control signal to the LED driving unit 26 according to a received control signal.

The LED driving unit 26 is connected with the lamp holder component 1, and is configured to control a lighting state of the lamp disc 11 of the lamp holder component 1 according to the LED control signal.

For example, the lighting state of the lamp disc 11 may be operated by adjusting brightness, switching on or off the lamp, and the like.

The second power source 24 is configured to reduce the voltage of the direct current and supply the direct current for the human-computer interaction control unit 25.

For example, the first power source 23 can output voltage of 310 V, and the voltage of the second power source 24 can be reduced to 3.3 V and then is output.

Specifically, the human-computer interaction control unit 25 may adopt modules such as Wi-Fi, BLE and Matter.

The control signal received by the human-computer interaction control unit 25 may be a signal from a switch, a remote controller, or intelligent equipment.

What needs illustration is that during the whole working process, the mains power supplied by the power supply end is first converted into direct current through the first power source 23, and then the direct current is supplied to the second power source 24 and the LED driving unit 26, respectively. The voltage of the second power source 24 is further reduced, and then is supplied for the human-computer interaction control unit 25. A user inputs control signals through the human-computer interaction control unit 25, and these signals are processed and output to the LED driving unit 26 to finally control the lighting state of LED lamp beads on the lamp disc 11.

The whole process achieves precise control for the lighting mechanism, so that the experience and use efficiency of the user are improved.

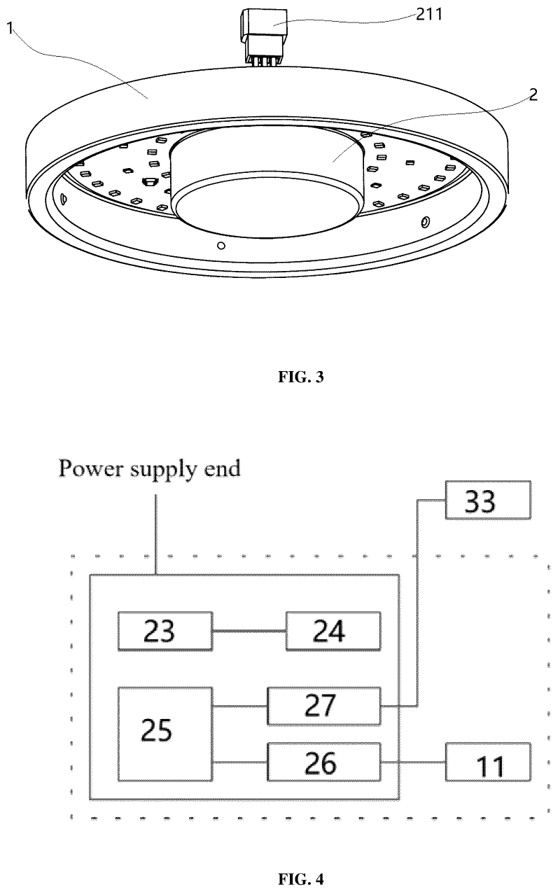

A lighting mechanism provided by a second embodiment of the present disclosure, as shown in FIG. 2, FIG. 3 and FIG. 4, includes a lamp holder component 1 and a controller 2.

The lamp holder component 1 is configured to provide lighting.

The controller 2 is integrated and arranged in the lamp holder component 1, and is connected with a power supply end to control a lighting function of the lamp holder component 1.

The controller 2 is integrated and arranged in the lamp holder component 1, and the demands of additional components and connecting wires are reduced, so that the installation process is simple and convenient, the installation time is saved, the installation cost and difficulty are reduced, and the risk of long-time high-place operation is reduced.

Of course, in order to accommodate the controller 2 in the lamp holder component 1, the lamp holder component 1 can be designed with a larger size, so that the lamp holder component 1 can become more concise.

The controller 2 is connected with the power supply end through a cable 21 with a plug connector 211. The installation and disassembly of the lighting mechanism are facilitated through the plug connector 211. At the same time, the reliability and safety of electrical connection are also ensured.

The lamp holder component 1 includes a lamp disc 11 and a lamp cover 12. The front of the lamp disc 11 is covered with the lamp cover 12, and the back of the lamp disc 11 is provided with the controller 2.

Additional installation space is saved by integrating the controller 2 on the lamp disc 11, so that the whole lighting mechanism is more compact and suitable for more space-constrained occasions.

The lamp disc 11 and the controller 2 are of an integrated structure, which reduces the number of components and connection steps during installation, so that the installation process is more convenient and faster.

The integrated structure enhances the connection strength between the lamp disc 11 and the controller 2, so that the stability of the overall structure is improved, and the risk of failure caused by loose components or poor connection is reduced.

The number of components and connection points are reduced, and the integrated structure enables the maintenance of the lighting mechanism to be simpler, so that the complexity and time cost during maintenance are reduced.

Further, the controller 2 includes a first power source 23, a second power source 24, a human-computer interaction control unit 25 and an LED (Light Emitting Diode) driving unit 26.

The first power source 23 has an input end connected with a power supply end and an output end respectively connected with the second power source 24 and the LED driving unit 26, and is configured to convert the mains power of the power supply end into direct current and supply direct current for the second power source 24 and the LED driving unit 26.

The second power source 24 has an input end connected with the first power source 23 and an output end connected with the human-computer interaction control unit 25, and is configured to reduce the voltage of the direct current and supply the direct current for the human-computer interaction control unit 25.

The man-machine interaction control unit 25 is connected with the LED driving unit 26, and is configured to output an LED control signal to the LED driving unit 26 according to a received control signal.

The LED driving unit 26 is connected with the lamp holder component 1, and is configured to control a lighting state of the lamp disc 11 of the lamp holder component 1 according to the LED control signal.

For example, the lighting state of the lamp disc 11 may be operated by adjusting brightness, switching on or off the lamp, and the like.

The second power source 24 is configured to reduce the voltage of the direct current and supply the direct current for the human-computer interaction control unit 25.

Specifically, the human-computer interaction control unit 25 may adopt modules such as Wi-Fi, BLE and Matter.

The control signal received by the human-computer interaction control unit 25 may be a signal from a switch, a remote controller, or intelligent equipment.

What needs illustration is that during the whole working process, the mains power supplied by the power supply end is first converted into direct current through the first power source 23, and then the direct current is supplied to the second power source 24 and the LED driving unit 26, respectively. The voltage of the second power source 24 is further reduced, and then is supplied for the human-computer interaction control unit 25. A user inputs control signals through the human-computer interaction control unit 25, and these signals are processed and output to the LED driving unit 26 to finally control the lighting state of LED lamp beads on the lamp disc 11.

The whole process achieves precise control for the lighting mechanism, so that the experience and use efficiency of the user are improved.

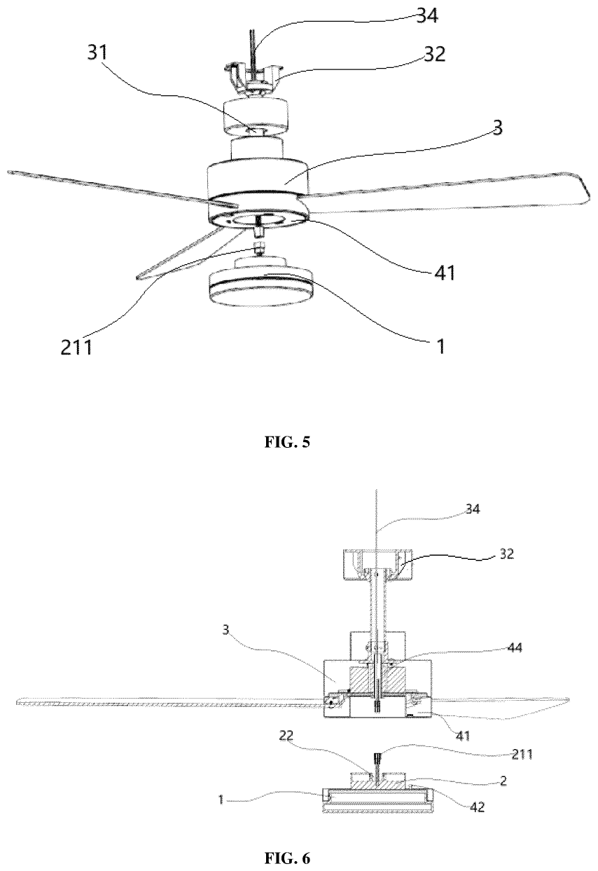

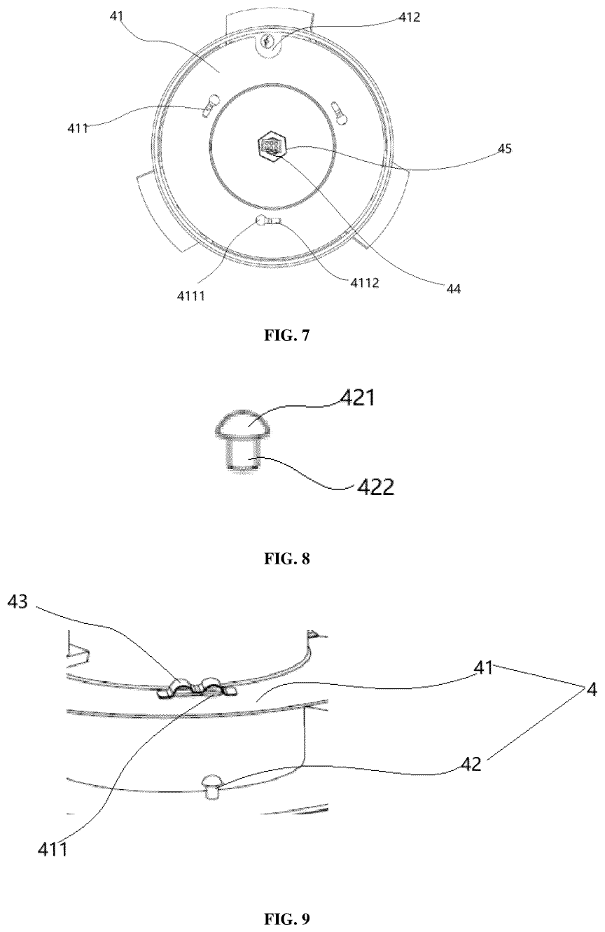

A ceiling fan lamp provided by a third embodiment of the present disclosure, as shown in FIG. 5 to FIG. 11, includes a ceiling fan body 3 and a lighting mechanism.

The lighting mechanism is connected with the ceiling fan body 3.

The controller 2 of the lighting mechanism is electrically connected with the ceiling fan body 3, and is configured to control a lighting function of the lamp holder component 1 and a working state of the ceiling fan body 3.

The ceiling fan body 3 only needs two power cords for penetration, so that the number of power cords needing penetration is reduced, the operation is simplified, the on-site installation time is saved, and an outer skin of the power cord is further prevented from being damaged. Due to the power cords and the controller 2 integrated and arranged on the lamp holder component 1 or inside the lamp holder component 1, the demands of additional components and connecting wires are reduced, so that the installation process is simple and convenient, the installation time is saved, the installation cost and difficulty are reduced, and the risk of long-time high-place operation is reduced.

The lighting mechanism includes a lamp holder component 1 and a controller 2.

The lamp holder component 1 is configured to provide lighting.

The controller 2 is integrated and arranged on the lamp holder component 1 or inside the lamp holder component 1, and is connected with a power supply end to control a lighting function of the lamp holder component 1.

The controller 2 is connected with the power supply end through a cable 21 with a plug connector 211. The installation and disassembly of the lighting mechanism are facilitated through the plug connector 211. At the same time, the reliability and safety of electrical connection are also ensured.

Specifically, the two power cords supplying mains power at the power supply end are connected to the plug connector 211 of the cable 21 after running through the ceiling fan body 3, and the plug connector 211 is electrically connected with the motor 33 of the ceiling fan body 3 through three power supply lines.

The lamp holder component 1 includes a lamp disc 11 and a lamp cover 12. The front of the lamp disc 11 is covered with the lamp cover 12, and the back of the lamp disc 11 is provided with the controller 2.

Additional installation space is saved by integrating the controller 2 on the lamp disc 11, so that the whole lighting mechanism is more compact and suitable for more space-constrained occasions.

The lamp disc 11 and the controller 2 are of an integrated structure, which reduces the number of components and connection steps during installation, so that the installation process is more convenient and faster.

The integrated structure enhances the connection strength between the lamp disc 11 and the controller 2, so that the stability of the overall structure is improved, and the risk of failure caused by loose components or poor connection is reduced.

The number of components and connection points are reduced, and the integrated structure enables the maintenance of the lighting mechanism to be simpler, so that the complexity and time cost during maintenance are reduced.

The controller 2 is provided with a cable duct 22 for cable 21 penetration. Through the cable duct 22, the cable 21 is further fixed and prevented from swinging at random.

Further, the controller 2 includes a first power source 23, a second power source 24, a human-computer interaction control unit 25, an LED driving unit 26 and a motor control unit 27.

The first power source 23 has an input end connected with a power supply end and an output end respectively connected with the second power source 24, the LED driving unit 26 and the motor control unit 27, and is configured to convert mains power of the power supply end into direct current and supply direct current for the second power source 24, the LED driving unit 26 and the motor control unit 27.

The second power source 24 has an input end connected with the first power source 23 and an output end connected with the human-computer interaction control unit 25, and is configured to reduce the voltage of the direct current and supply the direct current for the human-computer interaction control unit 25.

The man-machine interaction control unit 25 is connected with the LED driving unit 26 and the motor control unit 27, and is configured to output an LED control signal to the LED driving unit 26 according to a received control signal. The man-machine interaction control unit 25 is further configured to output a motor control signal to the motor control unit 27 according to the received control signal.

The LED driving unit 26 is connected with the lamp holder component 1, and is configured to control a lighting state of the lamp disc 11 of the lamp holder component 1 according to the LED control signal.

The motor control unit 27 is connected with the ceiling fan body 3, and is configured to control a working state of a motor 33 of the ceiling fan body 3 according to the motor control signal.

What needs illustration is that during the whole working process, the mains power supplied by the power supply end is first converted into direct current through the first power source 23, and then the direct current is supplied to the second power source 24, the Motor control unit 26 and the motor control unit 27, respectively. The voltage of the second power source 24 is further reduced, and then is supplied for the human-computer interaction control unit 25. A user inputs control signals through the human-computer interaction control unit 25, and these signals are processed and output to the LED driving unit 26 and/or the motor control unit 27 to finally control the lighting state of LED lamp beads on the lamp disc 11 and/or the working state of the motor 33.

The lighting mechanism is connected with the ceiling fan body 3 through a quick-connect mechanism 4.

Specifically, the quick-connect mechanism 4 includes an installation disc 41 and pegs 42.

The installation disc 41 is arranged on the ceiling fan body 3 and provided with at least two installation holes 411 matched with the pegs 42 at intervals along the circumferential direction.

The pegs 42 are arranged at corresponding positions on the back of the lamp disc 11.

For example, three installation holes 411 and three pegs 42 are provided in the circumferential direction.

The installation hole 411 includes a jacking hole 4111 and a rotary track 4112 sequentially connected along the circumferential direction. The diameter of the top entry hole 4111 is larger than the width of the rotary track 4112, so that successful insertion and rotary positioning of the pegs 42 are facilitated.

The peg 42 is composed of two parts such as a jacking hemisphere 421 and a sliding cylinder 422. The diameter of the jacking hemisphere 421 corresponds to the jacking hole 4111. The diameter of the sliding cylinder 422 corresponds to the width of a sliding track 4112.

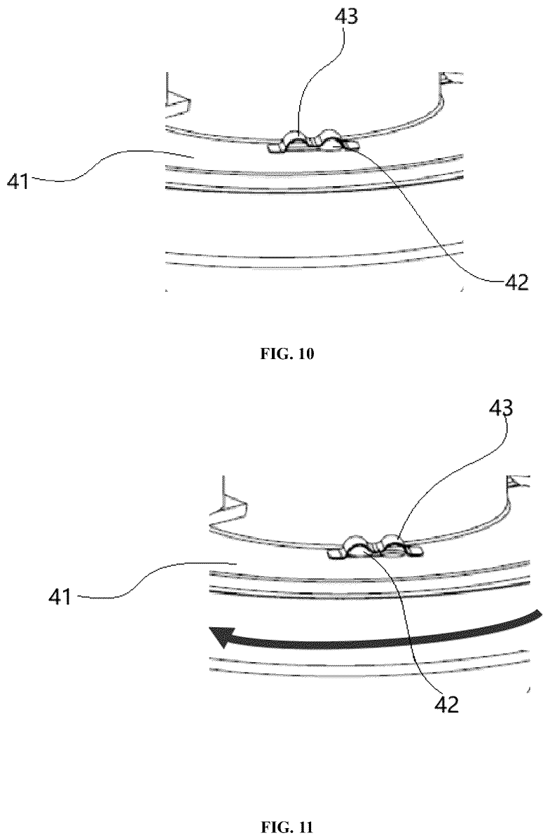

As shown in FIG. 9, after the jacking hemisphere 421 of the peg 42 stretches into the jacking hole 4111, the lamp holder component 1 is rotated, and the peg 42 moves along the sliding track 4112 (as shown in FIG. 10) to realize the connection between the lamp holder component 1 and the ceiling fan body 3 and finally realize positioning connection.

During disassembly, the lamp holder component 1 is rotated in the opposite direction. The peg 42 moves from the sliding track 4112 to the jacking hole 4111, and is separated from the installation hole (as shown in FIG. 11).

The installation disc 41 is provided with M-shaped compression spring plates 43 at corresponding positions of the installation holes 411. The M-shaped compression spring plate 43 is configured to position the pegs 42 installed in the installation holes 411.

Specifically, the M-shaped compression spring plate 43 is made of a metal sheet with a rebound characteristic, and is positioned on an upper surface of the installation disc 41 with a butt-welding or screw fastening method.

The height of the M-shaped compression spring plate 43 is slightly lower than the height of the jacking hemisphere 421. When the peg 42 moves along the sliding track 4112 of the installation hole 411, the M-shaped compression spring plate 43 is jacked up by the jacking hemisphere 421 (as shown in FIG. 10). When the peg 42 continues to move to an end position of the sliding track 4112, the jacking hemisphere 421 automatically resets. Downward force helps to position the peg 42 to prevent looseness.

The convenience of disassembly and assembly can be improved through the M-shaped compression spring plate 43. The device cannot be loosened or fall off when in use, is convenient for installation and maintenance, and has high environmental applicability and high practicability.

The edge of the installation disc 41 is provided with a U-shaped avoidance notch 412, so that a screwdriver stretches in the U-shaped avoidance notch 412 conveniently when fan blades are installed.

Further, the ceiling fan body 3 is connected with a hanging rack 32 arranged on a roof through a hanging rod 31. The power supply end passing through the hanging rod 31 and the ceiling fan body 3 through a power cord 34 to be electrically connected with the controller 2.

Further, the installation disc 41 is installed together with the ceiling fan body 3 in advance, the installation disc 41 is opened in the middle, penetrates into a motor threaded tube 44, and is locked 45 by a nut.

To sum up, the foregoing descriptions are merely examples of embodiments of the technical solutions of the present disclosure, but are not intended to limit the protection scope of the present disclosure.

1. A lighting mechanism, comprising a lamp holder component and a controller,
wherein the lighting mechanism is removable from a ceiling fan body;
wherein the lamp holder component is configured to provide lighting; and
wherein the controller is integrated and arranged on the lamp holder component or inside the lamp holder component, and is connected with a power supply end to control a lighting function of the lamp holder component, wherein the lamp holder component comprises a lamp disc and a lamp cover, a front of the lamp disc being covered with the lamp cover, and a back of the lamp disc being provided with the controller;
wherein the controller further comprises a human-computer interaction control unit, an LED (Light Emitting Diode) driving unit and a motor control unit;
wherein the human-computer interaction control unit is connected with the LED driving unit and the motor control unit, and is configured to output an LED control signal to the LED driving unit according to a received control signal and a motor control signal to the motor control unit according to the received control signal, wherein the received control signal is received through Wi-Fi or BLE; and
wherein the LED driving unit is configured to control a lighting state of the lamp disc of the lamp holder component according to the LED control signal, and the motor control unit is configured to control a working state of a motor of the ceiling fan body according to the motor control signal.

2. The lighting mechanism according to claim 1, wherein the controller is connected with a power supply end through a cable with a plug connector.

3. (canceled)

4. The lighting mechanism according to claim 1, wherein the lamp disc and the controller are of an integrated structure.

5. The lighting mechanism according to claim 1, wherein the controller is provided with a cable duct for cable penetration.

6. The lighting mechanism according to claim 1, wherein the controller further comprises a first power source, and a second power source;
wherein the first power source has an input end connected with a power supply end and an output end respectively connected with the second power source and the LED driving unit, and is configured to convert mains power of the power supply end into direct current and supply direct current for the second power source and the LED driving unit; and
wherein the second power source has an input end connected with the first power source and an output end connected with the human-computer interaction control unit, and is configured to reduce voltage of the direct current and supply the direct current for the human-computer interaction control unit.

7. A ceiling fan lamp, comprising the ceiling fan body and the lighting mechanism according to any one of claims 1 to 6,
wherein the lighting mechanism is coupled with the ceiling fan body, and the lighting mechanism is removable from the ceiling fan body; and
wherein the controller of the lighting mechanism is electrically connected with the ceiling fan body, and is configured to control a lighting function of the lamp holder component and a working state of the ceiling fan body.

8. The ceiling fan lamp according to claim 7, wherein the lighting mechanism is connected with the ceiling fan body through a quick-connect mechanism.

9. The ceiling fan lamp according to claim 8, wherein the quick-connect mechanism comprises an installation disc and pegs;
wherein the installation disc is arranged on the ceiling fan body and provided with at least two installation holes matched with the pegs at intervals along the circumferential direction; and
wherein the pegs are arranged at corresponding positions on the back of the lamp disc.

10. The ceiling fan lamp according to claim 9, wherein the installation disc is provided with M-shaped compression spring plates at corresponding positions of the installation holes, the M-shaped compression spring plate being configured to position the pegs installed in the installation holes.

11. The ceiling fan lamp according to claim 9, wherein the installation hole comprises a jacking hole and a rotary track sequentially connected along the circumferential direction; and wherein the diameter of the top entry hole is larger than the width of the rotary track.

12. The ceiling fan lamp according to claim 7, wherein the ceiling fan body is connected with a hanging rack arranged on a roof through a hanging rod, the power supply end passing through the hanging rod and the ceiling fan body through a power cord to be electrically connected with the controller.

13. (canceled)
